(19) United States
(12) Patent Application Publication
(10) Pub. No.: US 2025/0120797 A1
(43) Pub. Date: Apr. 17, 2025

(54) BOX ASSEMBLY

(71) Applicant: ShenZhen YUTO Packaging Technology Co., Ltd., Shenzhen (CN)

(72) Inventors: Zhiyong DING, Shenzhen (CN); Zongsheng YE, Shenzhen (CN)

(73) Assignee: ShenZhen YUTO Packaging Technology Co., Ltd., Shenzhen (CN)

(21) Appl. No.: 19/000,369

(22) Filed: Dec. 23, 2024

(30) Foreign Application Priority Data
Sep. 27, 2024 (CN) 202411376997.0

(51) Int. Cl. A61C 15/04

(52) U.S. Cl. CPC A61C 15/043

(57) ABSTRACT

The present application relates to a box assembly including a paper bottom box, a paper floss bobbin, and a cover component including a paper upper holder, a paper cover body, and a floss cutter. The paper bottom box includes a first accommodating cavity in which the paper floss bobbin and at least a portion of the paper upper holder are located. The paper upper holder is detachably connected to the paper bottom box only by friction fit and includes a second accommodating cavity and an outlet opening. The paper cover body is hinged with the paper upper holder and flipped relative to the paper upper holder to switch between open and closed positions. The floss cutter is arranged on the paper cover body. In the closed position, the paper cover body covers the second accommodating cavity and the outlet opening.

### CROSS-REFERENCES TO RELATED APPLICATIONS

The present application claims priority to Chinese Patent Application No. 202411376997.0 filed on Sep. 27, 2024, and titled “BOX ASSEMBLY”, which is incorporated herein by reference in its entirety.

### FIELD

The present application relates to the field of oral hygiene, in particular to a box assembly.

### BACKGROUND

A floss box is a small box assembly that can be used for holding a floss roll. The floss box can keep the floss roll clean. A user can conveniently carry the floss box. When the floss is used, a predetermined length (such as 25 centimeters or 33 centimeters) of floss is drawn from the floss box. Then the floss is supported by fingers to clean teeth. However, existing floss boxes are mainly made of plastic, which is not environment-friendly, so the discarded floss boxes lead to environmental pollution. Meanwhile, the plastic floss boxes have high hardness and strong pressure resistance. If environment-friendly materials (such as paper) are used to manufacture flosses with the same structure and replace plastic floss boxes, it is difficult to achieve the high hardness and strong pressure resistance of the plastic floss boxes.

### SUMMARY

Embodiments of the present application provide a box assembly, which has good environmental friendliness, makes the discarded box assembly less likely to pollute the environment, and satisfies the actually required hardness and pressure resistance.

The embodiments of the present application provide a box assembly, including a paper bottom box, a paper floss bobbin, and a cover component.

The paper bottom box includes a first accommodating cavity. The paper floss bobbin is arranged in the first accommodating cavity. The paper floss bobbin is used for supporting the floss roll. The cover component includes a paper upper holder, a paper cover body, and a floss cutter. At least a portion of the paper upper holder is located in the first accommodating cavity. The paper upper holder is detachably connected to the paper bottom box only by friction fit. The paper upper holder includes a second accommodating cavity and an outlet opening. The outlet opening connects the first accommodating cavity and the second accommodating cavity. The paper cover body is hinged with the paper upper holder. The paper cover body is flipped relative to the paper upper holder to switch between an open position and a closed position. The floss cutter is arranged on the paper cover body. In the case that the paper cover body is in the closed position, the paper cover body covers the second accommodating cavity and the outlet opening, and the floss cutter and at least a portion of the paper cover body are located in the second accommodating cavity. The paper cover body is connected to the paper upper holder only by friction fit. In the case that the paper cover body is in the open position, the outlet opening and the floss cutter are exposed.

The box assembly in the embodiments of the present application includes the paper bottom box, the paper floss bobbin, and the cover component, so a relatively small quantity of parts are used in the entire box assembly, which is conducive to reducing the assembly process and material usage of the box assembly, to reduce production costs, improving the ease of operation of replacing the floss roll, and improving user satisfaction. The paper bottom box, the paper floss bobbin, and the cover component can support each other, thereby ensuring that the assembled box assembly has relatively high structural strength and pressure resistance, also has a clean characteristic after the floss roll is installed, and is less prone to deformation and flattening. The paper bottom box is detachably connected to the paper upper holder only by friction fit, which facilitates the disassembly and assembly between the paper bottom box and the cover component, reduces the difficulties of disassembly and assembly operations, and improves the convenience of use. The paper cover body in the cover component is connected to the paper upper holder only by friction fit, which facilitates the connection and separation between the paper cover body and the paper upper holder, reduces the difficulty of opening and closing the paper cover body, and improves the convenience of use. The paper cover body can protect the paper upper holder and the floss cutter to reduce the possibility of contaminating the paper upper holder and the floss cutter. In the box assembly of the embodiments of the present application, the paper bottom box, the paper floss bobbin, the paper upper holder, and the paper cover body are all made of paper, which has good environmental friendliness, makes the discarded box assembly less likely to pollute the environment, can be recycled, meets environmental requirements.

In some embodiments, the paper upper holder and the paper cover are of a one-piece molded structure.

In some embodiments, the paper upper holder includes a first body and a first flange, the first body is located in the first accommodating cavity, the first body is detachably connected to the paper bottom box only by friction fit, the first body is provided with the second accommodating cavity and the outlet opening, and the paper cover body is hinged with the first flange.

In some embodiments, the paper cover body includes a second body and a second flange, the floss cutter is arranged on the second body, and the first flange is hinged with the second flange; in the case that the paper cover body is in the closed position, the first flange overlaps the second flange, the second body is located in the second accommodating cavity, and the second body is connected to the paper upper holder only by friction fit.

In some embodiments, the second body has a floss fixing portion, and the floss fixing portion is spaced apart from the floss cutter.

In some embodiments, the cover component includes a paper cover plate, the second body has a third accommodating cavity, an opening of the third accommodating cavity faces away from the paper upper holder, the paper cover plate is connected to the paper cover body, and the paper cover plate covers the third accommodating cavity.

In some embodiments, the paper floss bobbin includes a transverse bobbin portion and vertical bobbin portions, the transverse bobbin portion is used for supporting the floss roll, two ends of the transverse bobbin portion are lapped on the paper bottom box, the two vertical bobbin portions are spaced apart on the transverse bobbin portion, the vertical bobbin portions extend towards the paper upper holder, and the first body presses against the vertical bobbin portions.

In some embodiments, the paper bottom box includes two first recesses spaced apart, the first recesses are in communication with the first accommodating cavity, the first recess has a bottom wall, there is a distance between the bottom wall and a bottom surface of the first accommodating cavity, the two ends of the transverse bobbin portion are lapped on the bottom walls of the two first recesses separately, and at least a portion of the vertical bobbin portion is located in the first recess.

In some embodiments, the paper bottom box includes a third body and a third flange, the third body is provided with the first accommodating cavity, the first recesses are arranged on the third body, and the first flange overlaps the third flange.

In some embodiments, a portion of the third body protrudes to form first convex ribs, and the first convex ribs correspond to the first recesses.

In some embodiments, a portion of the first body protrudes to form second convex ribs, the second convex ribs are inserted into the first recesses, and the second convex ribs press against the vertical bobbin portions.

In some embodiments, the first body is provided with second recesses corresponding to the second convex ribs, and the second recesses are in communication with the second accommodating cavity.

In some embodiments, the first flange includes a first notch, the third flange includes a second notch, and the first notch corresponds to the second notch; in the case that the paper cover is in the closed position, the first flange, the second flange, and the third flange overlap, and a portion of the second flange is exposed in the first notch.

In some embodiments, the second body has an avoidance opening; the floss cutter includes a first clamping piece, a connecting piece, a second clamping piece, and a cutting blade; the connecting piece connects the first clamping piece and the second clamping piece, the connecting piece is inserted into the avoidance opening, the floss cutter is clamped to the second body through the first clamping piece and the second clamping piece, the first clamping piece is located on the side of the second body facing the paper upper holder, the second clamping piece is located on the side of the second body away from the paper upper holder, and the cutting blade is arranged on the first clamping piece.

In some embodiments, at least one of the paper bottom box, the paper floss bobbin, the paper upper holder, or the paper cover body is formed by curing raw materials including bamboo pulp and bagasse pulp, a total mass of the bamboo pulp in the raw materials accounts for 35%, and a total mass of the bagasse pulp in the raw materials accounts for 65%.

### BRIEF DESCRIPTION OF THE DRAWINGS

The embodiments of the present application will be described below with reference to the accompanying drawings.

FIG. 1 is a schematic structural view of a box assembly according to an embodiment of the present application;

FIG. 2 is a schematic structural view of the box assembly according to an embodiment of the present application;

FIG. 3 is a partial structural view of the box assembly in an open state according to an embodiment of the present application;

FIG. 4 is a partial structural view of a paper upper holder of a cover component according to an embodiment of the present application;

FIG. 5 is a partially exploded structural view of the box assembly according to an embodiment of the present application;

FIG. 6 is a partially exploded structural view of the box assembly containing a floss roll according to an embodiment of the present application;

FIG. 7 is a partial structural view of the cover component according to an embodiment of the present application;

FIG. 8 is a partial cross-sectional structural view of the cover component according to an embodiment of the present application;

FIG. 9 is a partial cross-sectional structural view of the box assembly according to an embodiment of the present application;

FIG. 10 is a partial cross-sectional structural view of the box assembly according to an embodiment of the present application;

FIG. 11 is a partial cross-sectional structural view of a paper bottom box according to an embodiment of the present application; and

FIG. 12 is a schematic structural view of the box assembly according to an embodiment of the present application.

In the drawings, the same reference numerals are used for the same components. The drawings are not drawn to actual scale.

### LIST OF REFERENCES

10. Box assembly;

20. Paper bottom box; 201. First accommodating cavity; 2011. Bottom surface; 202. First recess; 2021. Bottom wall; 21. Third body; 211. First convex rib; 22. Third flange; 221. Second notch;

30. Paper floss bobbin; 31. Transverse bobbin portion; 32. Vertical bobbin portion;

40. Cover component;

50. Paper upper holder; 501. Second accommodating cavity; 502. Outlet opening; 503. Second recess; 51. First body; 511. Second convex rib; 52. First flange; 521. First notch;

60. Paper cover body; 601. Third accommodating cavity; 61. Second body; 611. Avoidance opening; 612. Floss fixing portion; 62. Second flange;

70. Floss cutter; 71. First clamping piece; 72. Connecting piece; 73. Second clamping piece; 74. Cutting blade;

80. Paper cover plate;

100. Guide indentation;

200. Through hole;

300. Floss roll.

### DETAILED DESCRIPTION OF THE DISCLOSURE

Embodiments of the present application will be further described in detail below in conjunction with the accompanying drawings and embodiments. The detailed description of the following embodiments and the accompanying drawings are used for illustrating the principle of the present application, but cannot be used for limiting the scope of the present application, that is, the present application is not limited to the described embodiments.

In the description of the present application, it should be noted that, unless otherwise specified, “plurality of” means two or more; the orientations or positional relationships indicated by the terms “upper”, “lower”, “left”, “right”, “inner”, “outer”, etc. are only for facilitating description of the present application and simplifying the description, but do not indicate or imply that the pointed apparatuses or elements must have specific orientations or be constructed and operated in specific orientations. Therefore, the terms should not be understood to limit the present application. In addition, the terms “first”, “second”, “third”, and the like are for descriptive purposes only and should not be understood as indicating or implying relative importance. “Vertical” does not require being strictly vertical, but allows for an allowable range of error. “Parallel” does not require being strictly parallel, but allows for an allowable range of error.

The “embodiment” mentioned in the present application means that specific features, structures or characteristics described in conjunction with the embodiment may be included in at least one embodiment of the present application. The phrase appearing at various places in the description does not necessarily refer to the same embodiment, or an independent or alternative embodiment exclusive of other embodiments. Explicitly and implicitly that an embodiment described in the present application may be combined with other embodiments.

The orientation terms appearing in the following description all indicate directions shown in the drawings, and are not intended to limit specific structures of the present application. In the description of the present application, it should be noted that, unless otherwise specified and defined, the terms “mounted”, “connected”, and “connection” should be understood in a broad sense, for example, the “connection” may be fixed connected, detachable connection, integral connection, direct connection, or indirect connection by a medium. The specific meanings of the above terms in the present application according to specific circumstances.

The embodiments of the present application provide a box assembly, which has environmental friendliness and can replace existing plastic box assemblies by clever structural design. The entire box assembly in the embodiments of the present application has strong structural strength and pressure resistance. Therefore, the box assembly in the embodiments of the present application is less prone to deformation, crushing, and other problems during daily repeated use. The box assembly in the embodiments of the present application is made of an environment-friendly material, making it less likely to pollute the environment after being discarded.

In order to better understand the present application, the box assembly in the embodiments of the present application will be described below in conjunction with the accompanying drawings.

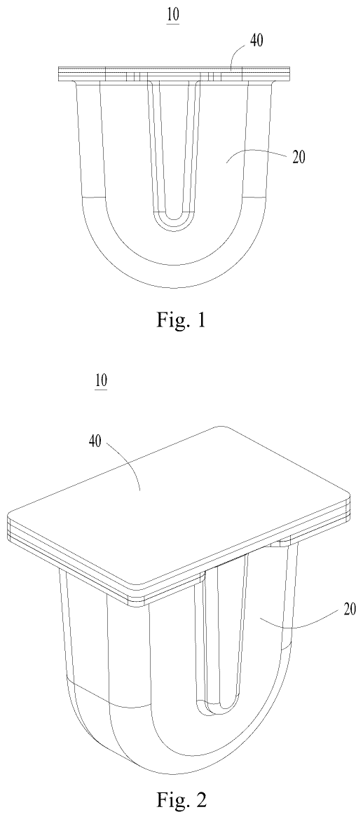

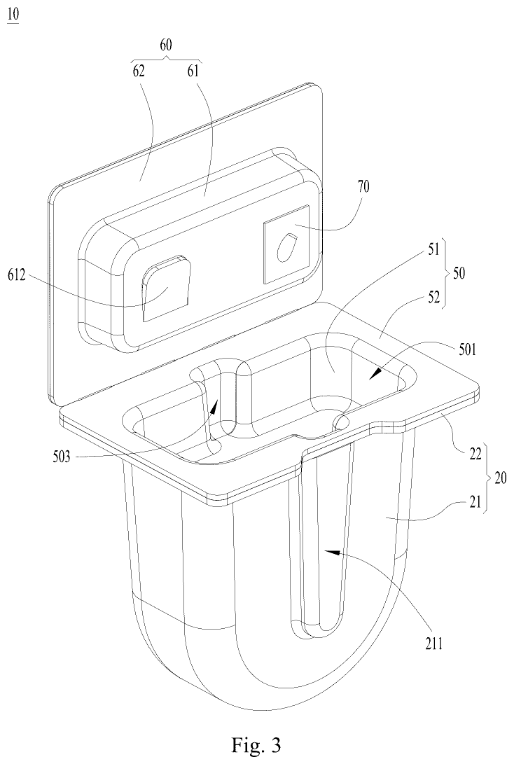

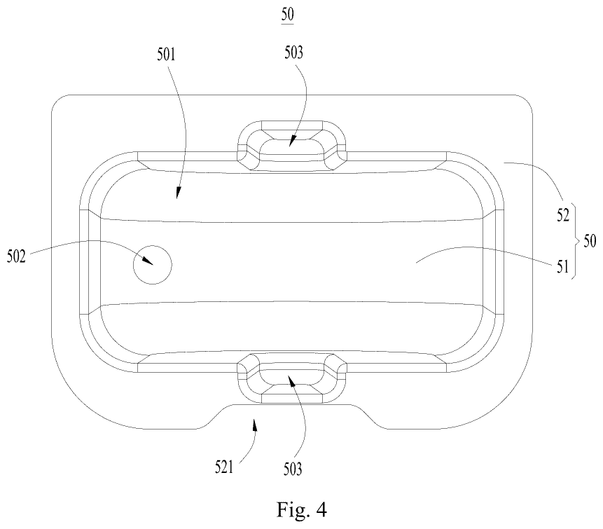

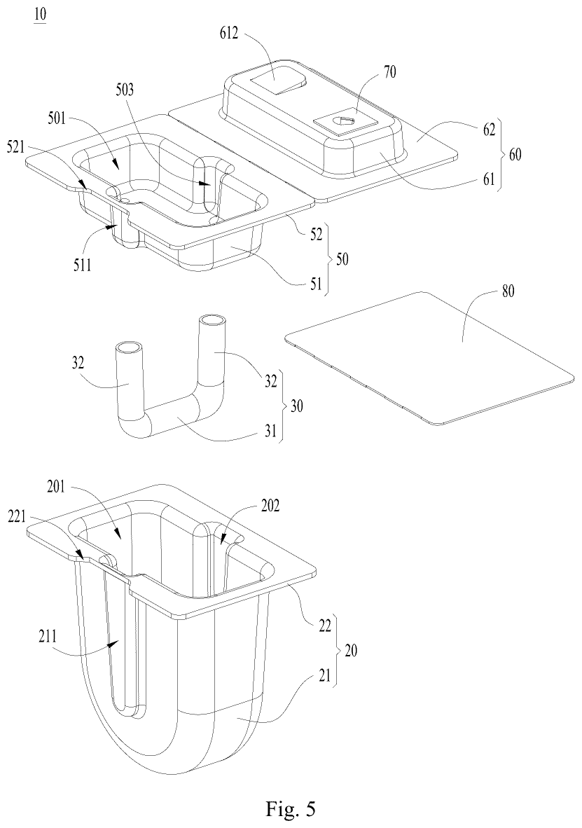

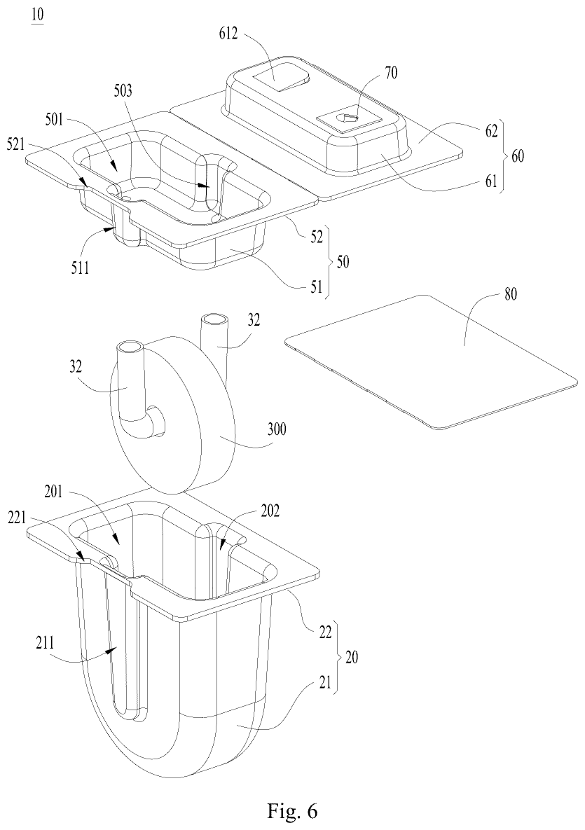

FIG. 1 illustrates a structure of a box assembly 10. FIG. 2 illustrates a structure of the box assembly 10. FIG. 3 illustrates a partial structure of the box assembly 10 in an open state. FIG. 4 illustrates a partial structure of a paper upper holder 50 of a cover component 40. FIG. 5 illustrates a partially exploded structure of the box assembly 10. FIG. 6 illustrates a partially exploded structure of the box assembly 10 containing a floss roll 300.

As shown in FIG. 1 to FIG. 6, embodiments of the present application provide a box assembly 10, including a paper bottom box 20, a paper floss bobbin 30, and a cover component 40.

The paper bottom box 20 includes a first accommodating cavity 201. The paper floss bobbin 30 is arranged in the first accommodating cavity 201. The paper floss bobbin 30 is used for supporting the floss roll 300.

The cover component 40 includes a paper upper holder 50, a paper cover body 60, and a floss cutter 70. At least a portion of the paper upper holder 50 is located in the first accommodating cavity 201. The paper upper holder 50 is detachably connected to the paper bottom box 20 only by friction fit. The paper upper holder 50 includes a second accommodating cavity 501 and an outlet opening 502. The outlet opening 502 connects the first accommodating cavity 201 with the second accommodating cavity 501. The paper cover body 60 is hinged with the paper upper holder 50. The paper cover body 60 is flipped relative to the paper upper holder 50 to switch between an open position and a closed position. The floss cutter 70 is arranged on the paper cover body 60.

In the case that the paper cover body 60 is in the closed position, the paper cover body 60 covers the second accommodating cavity 501 and the outlet opening 502, and the floss cutter 70 and at least a portion of the paper cover body 60 are located in the second accommodating cavity 501. The paper cover body 60 is connected to the paper upper holder 50 only by friction fit. In the case that the paper cover body 60 is in the open position, the outlet opening 502 and the floss cutter 70 are exposed.

In the embodiments of the present application, the box assembly 10 may be used by a user as follows: the user holds the paper bottom box 20 and opens the paper cover body 60 in the cover component 40; the user pinches with his or her fingers the floss led out of the outlet opening 502 of the paper upper holder 50, and then pull the floss to draw a predetermined length (such as 25 centimeters or 33 centimeters) of floss; the user places and cut the floss at the floss cutter 70, closes the paper cover body 60, and places the box assembly 10 down; the user can shape and support the floss with fingers, and the fingers guide the floss to clean teeth. After cleaning, the floss is discarded. The floss may be a nylon thread, a silk thread, or a polyester thread.

After the floss roll 300 inside the box assembly 10 is used up, the entire cover component 40 can be separated and removed from the paper bottom box 20. Then, the paper floss bobbin 30 is lifted and is removed from the paper bottom box 20. A new floss roll 300 is reinstalled on the paper floss bobbin 30. The paper floss bobbin and the floss roll 300 are loaded into the first accommodating cavity 201 of the paper bottom box 20. A floss end of the floss roll 300 is threaded through the outlet opening 502 of the paper upper holder 50, and the paper upper holder 50 is installed in the paper bottom box 20. Finally, the paper cover body 60 is flipped to the closed position, and the box assembly 10 can continue to be reused. Therefore, in embodiments of the present application, not only the material but also the usage is environment-friendly.

The paper bottom box 20 in the embodiments of the present application is a box usually in contact with user's hands. The paper bottom box 20 can protect the paper upper holder 50, to prevent the user's fingers from touching the paper upper holder 50, to reduce the possibility of contaminating the paper upper holder 50 by bacteria or dirt carried by the fingers. At least a portion of the paper upper holder 50 is located in the first accommodating cavity 201. The portion of the paper upper holder 50 in the paper bottom box 20 is detachably connected to the paper bottom box 20 by friction fit only. The friction fit belongs to interference fit.

The entire cover component 40 is connected to the paper bottom box 20 through the paper upper holder 50. In the case that the paper upper holder 50 needs to be removed from the paper bottom box 20 to separate the cover component 40 and the paper bottom box 20, a pull force is applied to the paper upper holder 50 to overcome the friction between the paper upper holder 50 and the paper bottom box 20, to separate the paper upper holder 50 from the paper bottom box 20. In the case that the paper upper holder 50 needs to be loaded into the paper bottom box 20 to connect the cover component 40 with the paper bottom box 20, pressure is applied to the paper upper holder 50 to overcome the friction between the paper upper holder 50 and the paper bottom box 20, to assemble the paper upper holder 50 and the paper bottom box 20.

The paper upper holder 50 is detachably connected to the paper bottom box 20 only by friction fit, so no additional connector is required between the paper upper holder 50 and the paper bottom box 20. The quantity of parts of the entire box assembly 10 can be reduced, and the assembly process can be reduced, while the paper upper holder 50 and the paper bottom box 20 are easy to disassemble and assemble, which is conducive to reducing difficulties in reuse of the box assembly 10 and replacement of the floss roll 300 and improving the usability of the box assembly 10.

The paper floss bobbin 30 is located below the paper upper holder 50. The paper floss bobbin 30 is used for supporting the floss roll 300. The floss roll 300 is rotatably connected to the paper floss bobbin 30. In the case that the user pulls the floss through the outlet opening 502 of the paper upper holder 50, the floss roll 300 rotates on the paper floss bobbin 30. The floss roll 300 has a central insertion hole. In the case that the floss roll 300 is replaced, the paper floss bobbin 30 is inserted into the central insertion hole of the floss roll 300.

The floss cutter 70 is arranged on the paper cover body 60. The box assembly 10 is provided with the floss cutter 70, which enables the user to use the floss cutter 70 conveniently to cut the floss led out from the outlet opening 502. Therefore, the user does not need to carry an additional tool for cutting the floss, to improve the convenience of using the box assembly 10. For example, the material of the floss cutter 70 may include metal materials such as steel and iron.

The paper cover body 60 is connected to the paper upper holder 50, so in the case that the paper cover body 60 is opened, the paper cover body 60 does not need to be removed and placed in another area, which reduces the possibility of losing the paper cover body 60. Meanwhile, the paper cover body 60 can be opened or closed only by flipping the paper cover body 60, which is conducive to improving the convenience of operating the paper cover body 60 and improving the usability of the box assembly 10.

In the case that the paper cover body 60 is in the closed position, the paper cover body 60 closes the second accommodating cavity 501. The floss cutter 70 is located in the second accommodating cavity 501. The paper cover body 60 can protect the paper upper holder 50 and the floss cutter 70, to reduce the possibility of contaminating the paper upper holder 50 and the floss cutter 70. In the case that the paper cover body 60 is in the open position, the paper cover body 60 opens the second accommodating cavity 501. The outlet opening 502 of the paper upper holder 50 and the floss cutter 70 on the paper cover body 60 are exposed, making it easy for the user to pull and cut the floss.

At least a portion of the paper cover body 60 is located in the second accommodating cavity 501. The portion of the paper cover body 60 in the second accommodating cavity 501 is connected to the paper upper holder 50 only by friction fit.

In the case that the paper cover body 60 needs to be removed from the paper upper holder 50 to open the paper cover body 60, a flipping torque is applied to the paper cover body 60 to overcome the friction between the paper upper holder 50 and the paper cover body 60, to separate the paper upper holder 50 from the paper cover body 60. In the case that the paper cover body 60 needs to be connected to the paper upper holder 50 to close the paper cover body 60, pressure is applied to the paper cover body 60 to overcome the friction between the paper upper holder 50 and the paper cover body 60, to connect the paper cover body 60 and the paper upper holder 50.

The paper upper holder 50 is connected to the paper cover body 60 only by friction fit, so no additional connector is required between the paper upper holder 50 and the paper cover body 60. The quantity of parts of the entire box assembly 10 can be reduced, and the assembly process can be reduced, while the paper upper holder 50 and the paper cover body 60 are easy to disassemble and assemble, which is conducive to reducing difficulties in reuse of the box assembly 10 and replacement of the floss roll 300 and improving the usability of the box assembly 10.

The box assembly 10 in the embodiments of the present application includes the paper bottom box 20, the paper floss bobbin 30, and the cover component 40, so a relatively small quantity of parts are used in the entire box assembly 10, which is conducive to reducing the assembly process and material usage of the box assembly 10, to reduce production costs, improving the ease of operation of replacing the floss roll 300, and improving user satisfaction. The paper bottom box 20, the paper floss bobbin 30, and the cover component 40 can support each other, to ensure that the assembled box assembly 10 has relatively high structural strength and pressure resistance, also has the above clean characteristic after the floss roll 300 is installed, and is less prone to deformation and flattening. The paper bottom box 20 is detachably connected to the paper upper holder 50 only by friction fit, which facilitates the disassembly and assembly between the paper bottom box 20 and the cover component 40, reduces the difficulties of disassembly and assembly operations, and improves the convenience of use. The paper cover body 60 in the cover component 40 is connected to the paper upper holder 50 only by friction fit, which facilitates the connection and separation between the paper cover body 60 and the paper upper holder 50, reduces the difficulty of opening and closing the paper cover body 60, and improves the convenience of use. The paper cover body 60 can protect the paper upper holder 50 and the floss cutter 70 to reduce the possibility of contaminating the paper upper holder 50 and the floss cutter 70. In the box assembly 10 of the embodiments of the present application, the paper bottom box 20, the paper floss bobbin 30, the paper upper holder 50, and the paper cover body 60 are all made of paper, which has good environmental friendliness, makes the discarded box assembly 10 less likely to pollute the environment, can be recycled, meets environmental requirements.

In some embodiments, the paper bottom box 20, the paper floss bobbin 30, the paper upper holder 50, and the paper cover body 60 can all be manufactured using a pulp molding process.

In some embodiments, the frictional force between the paper upper holder 50 and the paper bottom box 20 is greater than that between the paper cover body 60 and the paper upper holder 50. In the case that the paper cover body 60 needs to be flipped from the closed position to the open position, the force applied to the paper cover body 60 can separate the paper cover body 60 from the paper upper holder 50, but the force is less than the frictional force between the paper upper holder 50 and the paper bottom box 20, so the force will not separate the paper upper holder 50 from the paper bottom box 20, to reduce the possibility of separating the paper upper holder 50 from the paper bottom box 20 in the case that flipping the paper cover body 60.

In some embodiments, the paper bottom box 20 is of a one-piece molded structure, which is conducive to ensuring good structural strength of the paper bottom box 20 and can reduce the processing difficulty of the paper bottom box 20.

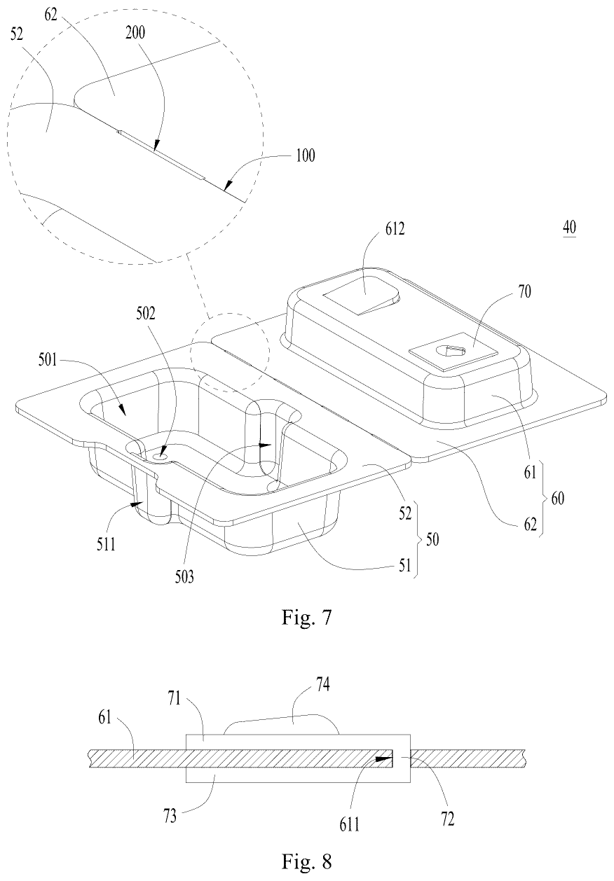

FIG. 7 illustrates a partial structure of the cover component 40. In some embodiments, as shown in FIG. 7, the paper upper holder 50 and the paper cover body 60 are of a one-piece molded structure, and the paper upper holder 50 and the paper cover body 60 do not need to be separately processed and then hinged by connectors, which is conducive to reducing the difficulty of processing and assembling the cover component 40.

A pulp molding process can be used for manufacturing the paper upper holder 50 and the paper cover body 60 molded into one piece. After the paper upper holder 50 and the paper cover body 60 are processed, a guide indentation 100 is arranged between the paper upper holder 50 and the paper cover body 60, and the paper cover body 60 can be flipped relative to the paper upper holder 50 at the guide indentation 100. The paper upper holder 50 and the paper cover body 60 are hinged at the guide indentation 100.

In some embodiments, the cover component 40 is provided with spaced through holes 200 in an area corresponding to the guide indentation 100 to remove some material, which is conducive to reducing the connection area between the paper cover body 60 and the paper upper holder 50, reducing the flipping torque required to flip the paper cover body 60, and enabling the user to flip the paper cover body 60 with relatively small force.

In some embodiments, as shown in FIGS. 2, 3, 4, and 7, the paper upper holder 50 includes a first body 51 and a first flange 52. The first body 51 is located in the first accommodating cavity 201 of the paper bottom box 20. The first body 51 is detachably connected to the paper bottom box 20 only by friction fit. The first body 51 is provided with the second accommodating cavity 501 and the outlet opening 502. The paper cover body 60 is hinged with the first flange 52.

The first flange 52 is arranged at an opening of the first body 51. In the case that the first body 51 of the paper upper holder 50 is pressed into the first accommodating cavity 201 of the paper bottom box 20, after the first body 51 is pressed by a predetermined depth, the first flange 52 comes into contact with the paper bottom box 20, to limit the first body 51 from being further pressed into the first accommodating cavity 201. Therefore, the first flange 52 can be used for limiting and constraining the first body 51, to ensure that the first body 51 is accurately pressed into the paper bottom box 20 by the predetermined depth, to reduce the difficulty of assembly between the paper upper holder 50 and the paper bottom box 20, and reducing the possibility that the entire unconstrained paper upper holder 50 is pressed into the paper bottom box 20 and the paper upper holder 50 is difficult to remove accordingly.

In some embodiments, the smoothness of an outer surface of the paper bottom box 20 is greater than that of an inner surface of the paper bottom box 20, and the user can have a good tactile sensation when touching the outer surface of the paper bottom box 20. The outer surface of the paper bottom box 20 is relatively smoother. The relatively rough inner surface of the paper bottom box 20 is conducive to increasing the friction between the first body 51 and the paper bottom box 20 and improving the stability of connection between the paper upper holder 50 and the paper bottom box 20.

For example, the surface of the first body 51 facing the paper bottom box 20 is a rough surface, which is conducive to further increasing the friction between the first body 51 and the paper bottom box 20 and improving the stability of connection between the paper upper holder 50 and the paper bottom box 20.

In some embodiments, the outlet opening 502 of the paper upper holder 50 may be arranged at a bottom of the second accommodating cavity 501.

In some embodiments, as shown in FIG. 7, the paper cover body 60 includes a second body 61 and a second flange 62. The floss cutter 70 is arranged on the second body 61. The first flange 52 is hinged with the second flange 62. In the case that the paper cover body 60 is in the closed position, the first flange 52 of the paper upper holder 50 overlaps with the second flange 62 of the paper cover body 60, and the second body 61 of the paper cover body 60 is located in the second accommodating cavity 501 of the paper upper holder 50. The second body 61 of the paper cover body 60 is connected to the paper upper holder 50 only by friction fit.

The second flange 62 is arranged at an opening of the second body 61. In the case that the second body 61 of the paper cover body 60 is pressed into the second accommodating cavity 501 of the paper upper holder 50, after the second body 61 is pressed by a predetermined depth, the second flange 62 comes into contact with the first flange 52 of the paper upper holder 50, to limit the second body 61 from being further pressed into the second accommodating cavity 501. Therefore, the second flange 62 can be used for limiting and constraining the second body 61, to ensure that the second body 61 is accurately pressed into the paper upper holder 50 by the predetermined depth, to reduce the difficulty of operating the paper cover body 60 in the closing process, and reducing the possibility that the entire unconstrained paper cover body 60 is pressed into the paper upper holder 50 to make the paper cover body 60 deform or difficult to draw out.

In the case that the paper cover body 60 is in the closed position, there is a gap between the second body 61 and the bottom of the second accommodating cavity 501 to prevent the floss cutter 70 from being in contact with the paper upper holder 50. The floss end of the floss roll 300 and the floss cutter 70 may be located in the gap.

In some embodiments, the floss cutter 70 may be arranged at a bottom of the second body 61. The floss cutter 70 may be bonded to the second body 61. For example, the floss cutter 70 may be bonded to the second body 61 with an adhesive or double-sided adhesive tape.

In some embodiments, FIG. 8 illustrates a partial cross-sectional structure of the cover component 40. As shown in FIG. 7 and FIG. 8, the second body 61 has an avoidance opening 611. The floss cutter 70 includes a first clamping piece 71, a connecting piece 72, a second clamping piece 73, and a cutting blade 74. The connecting piece 72 connects the first clamping piece 71 and the second clamping piece 73. The connecting piece 72 is inserted into the avoidance opening 611. The floss cutter 70 is clamped to the second body 61 through the first clamping piece 71 and the second clamping piece 73. The first clamping piece 71 is located on a side of the second body 61 facing the paper upper holder 50. The first clamping piece 71 faces the paper upper holder 50. The second clamping piece 73 is located on a side of the second body 61 away from the paper upper holder 50. The cutting blade 74 is arranged on the first clamping piece 71. The cutting blade 74 is used for cutting the floss.

The floss cutter 70 is clamped to the second body 61 through the first clamping piece 71 and the second clamping piece 73, to connect and fix the floss cutter 70 and the second body 61, so no additional connector (such as adhesive) is required between the floss cutter 70 and the second body 61, which is conducive to reducing the quantity of parts of the entire box assembly 10 and improving the environmental friendliness of the box assembly 10.

The assembly process of the floss cutter 70 and the second body 61 may be as follows: The second clamping piece 73 is allowed to pass through the avoidance opening 611 of the second body 61 from one side of the second body 61, then the floss cutter 70 is pushed, the second clamping piece 73 passes through the avoidance opening 611 and enters the other side of the second body 61, and the connecting piece 72 is inserted into the avoidance opening 611. Then, the first clamping piece 71 is released, and the first clamping piece 71, the connecting piece 72, and the second clamping piece 73 restore to their initial state. The first clamping piece 71 and the second clamping piece 73 clamp the second body 61.

In some embodiments, as shown in FIG. 7, the second body 61 has a floss fixing portion 612 spaced apart from the floss cutter 70.

The floss passing through the outlet opening 502 can be fixed to the floss fixing portion 612, which reduces the possibility of knotting and tangling of the unconstrained floss and can also reduce the possibility of accidental retraction of the floss into the first accommodating cavity 201. For example, there is a gap between the floss fixing portion 612 and the second body 61. The floss can pass through the gap, and the floss fixing portion 612 can press the floss.

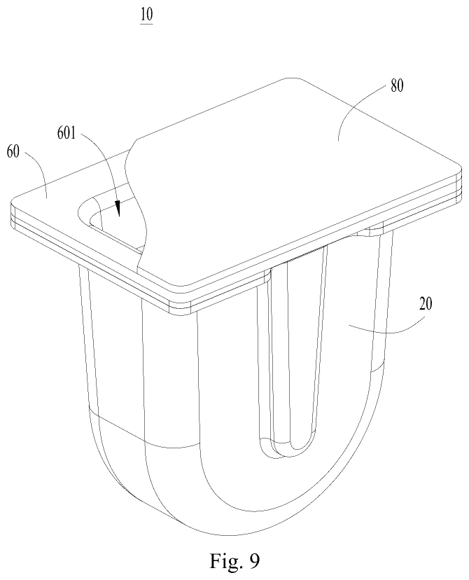

In some embodiments, FIG. 9 illustrates a partial cross-sectional structure of the box assembly 10. As shown in FIG. 6 and FIG. 9, the cover component 40 includes a paper cover plate 80. The second body 61 has a third accommodating cavity 601. An opening of the third accommodating cavity 601 faces away from the paper upper holder 50. The paper cover plate 80 is connected to the paper cover body 60. The paper cover plate 80 covers the third accommodating cavity 601.

The second body 61 is provided with the third accommodating cavity 601, which can reduce material usage for the second body 61 and lower processing costs, and facilitate de-molding of the paper cover plate 80 and reduce the difficulty of processing the paper cover plate 80 in the case that the paper cover plate 80 is formed using the pulp molding process.

The paper cover plate 80 can cover the third accommodating cavity 601 of the paper cover body 60, which can ensure that the overall appearance of the cover component 40 is clean and attractive and improve the overall aesthetics of the cover component 40, and reduce the possibility that impurities and dirt enter the third accommodating cavity 601 and accumulate in the third accommodating cavity 601 and ensure that the cover component 40 has good cleanliness.

For example, the paper cover plate 80 may be bonded to the surface of the second flange 62 of the paper cover body 60 away from the paper upper holder 50. For example, the paper cover plate 80 may be bonded to the second flange 62 with an adhesive or double-sided adhesive tape.

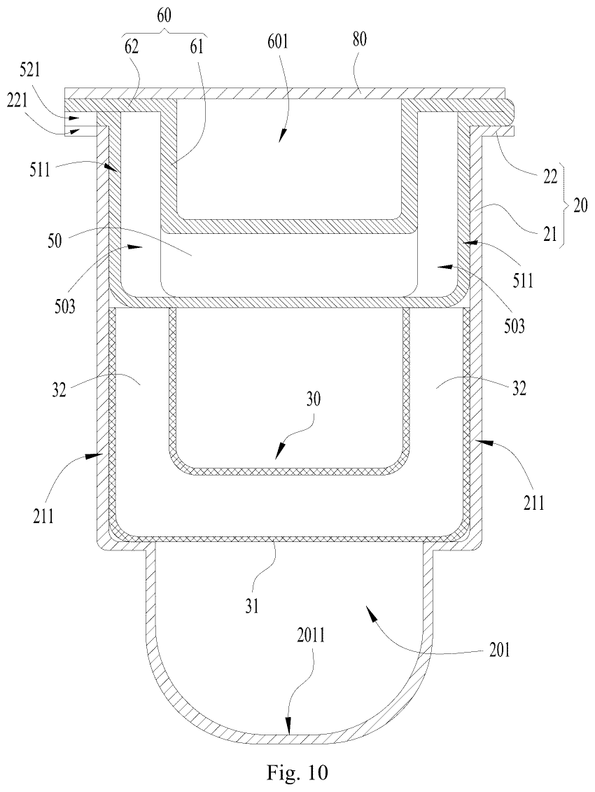

In some embodiments, FIG. 10 illustrates a partial cross-sectional structure of the box assembly 10. As shown in FIGS. 5, 6, and 10, the paper floss bobbin 30 includes a transverse bobbin portion 31 and vertical bobbin portions 32. The transverse bobbin portion 31 is used for supporting the floss roll 300. Two ends of the transverse bobbin portion 31 are lapped on the paper bottom box 20. The two vertical bobbin portions 32 are spaced apart on the transverse bobbin portion 31. The vertical bobbin portions 32 extend towards the paper upper holder 50. In the case that the paper upper holder 50 is pressed into the paper bottom box 20 by the predetermined depth, the first body 51 of the paper upper holder 50 presses against the vertical bobbin portions 32 to fix the paper floss bobbin 30, which prevents the paper floss bobbin 30 from loosening and shaking.

The vertical bobbin portions 32 of the paper floss bobbin 30 can be bent relative to the transverse bobbin portion 31. After the paper floss bobbin 30 is pressed into the paper bottom box 20, the vertical bobbin portions 32 have elastic recovery force. Under the elastic recovery force of the vertical bobbin portions 32, the vertical bobbin portions 32 can stably press against the inner surface of the paper bottom box 20 to prevent the paper floss bobbin 30 from loosening and shaking.

For example, the paper floss bobbin 30 can be formed by bending a paper tube with an outer diameter of 5 millimeters (mm) and a wall thickness of 1.5 millimeters, which facilitates the production of the paper floss bobbin 30.

In the case that the paper floss bobbin 30 is removed from the paper bottom box 20, the transverse bobbin portion 31 can be pulled to apply a force to the paper floss bobbin 30, to remove the paper floss bobbin 30 from the paper bottom box 20. In the case that the floss roll 300 is replaced, one of the vertical bobbin portions 32 is inserted into the central insertion hole of the floss roll 300, the paper floss bobbin 30 is further moved until the transverse bobbin portion 31 passes through the central insertion hole of the floss roll 300, and then the paper floss bobbin 30 is stopped from moving. Then, the paper floss bobbin 30 containing the floss roll 300 is pressed into the paper bottom box 20 again.

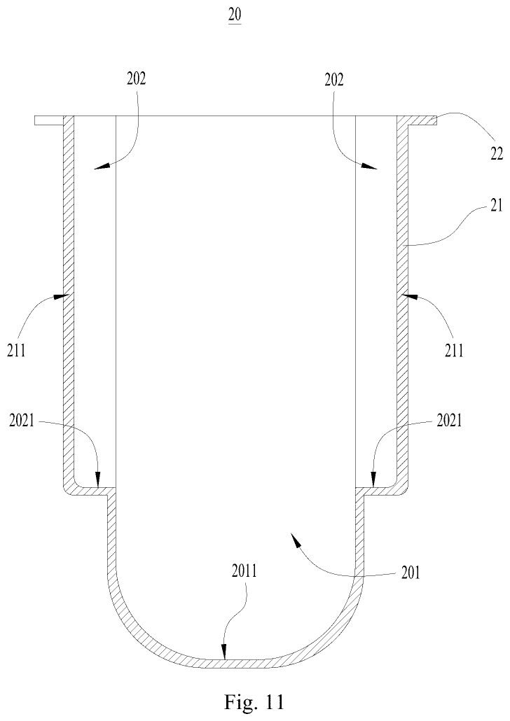

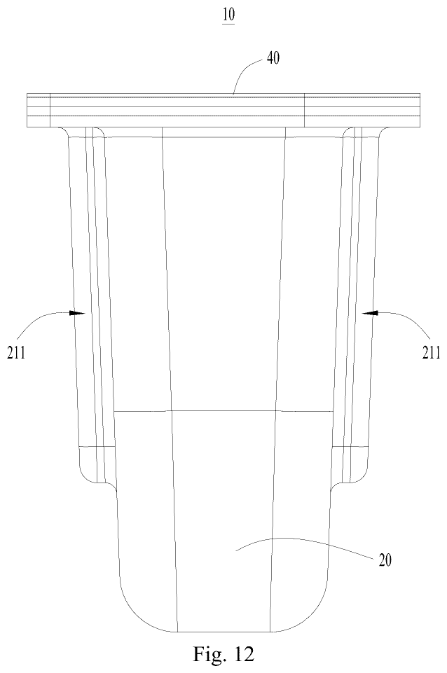

In some embodiments, FIG. 11 illustrates a partial cross-sectional structure of the paper bottom box 20. As shown in FIG. 10 and FIG. 11, the paper bottom box 20 includes two first recesses 202 spaced apart. The first recesses 202 of the paper bottom box 20 are in communication with the first accommodating cavity 201. The first recess 202 has a bottom wall 2021. There is a gap between the bottom wall 2021 of the first recess 202 and a bottom surface 2011 of the first accommodating cavity 201. The transverse bobbin portion 31 of the paper floss bobbin 30 has two opposite ends. The two ends of the transverse bobbin portion 31 correspond to the two first recesses 202 separately. The two ends of the transverse bobbin portion 31 are lapped on the bottom walls 2021 of the two first recesses 202 separately. At least a portion of the vertical bobbin portion 32 is located in the first recess 202.

In the case that the paper floss bobbin 30 is loaded into the paper bottom box 20, the first recesses 202 can provide positioning and guidance for the paper floss bobbin 30, to accurately and quickly press the paper floss bobbin 30 into the paper bottom box 20, to reduce the assembly difficulty between the paper floss bobbin 30 and the paper bottom box 20.

The bottom walls 2021 of the first recesses 202 can limit the paper floss bobbin 30. After the paper floss bobbin 30 is pressed into the paper bottom box 20 by the predetermined depth, the paper floss bobbin 30 comes into contact with the bottom walls 2021 of the first recesses 202, to limit the paper floss bobbin 30 from being further pressed in. Therefore, the bottom walls 2021 of the first recesses 202 can limit and constrain the paper floss bobbin 30, to ensure that the paper floss bobbin 30 is accurately pressed into the paper bottom box 20 by the predetermined depth, to reduce the difficulty in assembly of the paper floss bobbin 30 and the paper bottom box 20, and reducing the possibility that the unconstrained paper floss bobbin 30 is pressed into the paper bottom box 20 too deep and the floss bobbin 300 comes into contact with the paper bottom box 20 accordingly.

The gap between the bottom wall 2021 of the first recess 202 and the bottom surface 2011 of the first accommodating cavity 201 needs to meet the requirement that the floss roll 300 on the paper floss bobbin 30 is not in contact with the paper bottom box 20 after the paper floss bobbin 30 is installed in place, to ensure the gap between the floss roll 300 and the paper bottom box 20 and preventing scratching between the floss roll 300 and the paper bottom box 20 in the case that the floss roll 300 rotates.

The vertical bobbin portion 32 is located in the first recess 202, and the paper bottom box 20 limits the vertical bobbin portion 32, and the paper floss bobbin 30 will not rotate relative to the paper bottom box 20 in the process of pulling the floss.

In some embodiments, as shown in FIGS. 5, 10, and 11, the paper bottom box 20 includes a third body 21 and a third flange 22. The third body 21 is provided with the first accommodating cavity 201. The first recesses 202 are arranged on the third body 21. The first flange 52 of the paper upper holder 50 overlaps with the third flange 22 of the paper bottom box 20.

The third flange 22 is arranged at an opening of the third body 21. In the case that the first body 51 of the paper upper holder 50 is pressed into the first accommodating cavity 201 of the paper bottom box 20, after the first body 51 is pressed by the predetermined depth, the first flange 52 of the paper upper holder 50 comes into contact with the third flange 22 of the paper bottom box 20, to limit the first body 51 from being further pressed into the first accommodating cavity 201. The first flange 52 of the paper upper holder 50 overlaps the third flange 22 of the paper bottom box 20, and the first flange 52 and the third flange 22 can support each other to reduce the possibility of folding deformation of the first flange 52 and the third flange 22 by external force.

In some embodiments, as shown in FIG. 9 and FIG. 11, a bottom of the third body 21 may be arc-shaped, making it easy to grip the paper bottom box 20.

In some embodiments, FIG. 12 illustrates a structure of the box assembly 10. As shown in FIGS. 5, 10, and 12, a portion of the third body 21 protrudes to form first convex ribs 211. The first convex ribs 211 correspond to the first recesses 202.

In the case that the paper bottom box 20 is processed, the first convex ribs 211 and the first recesses 202 can be formed in the same process, to reduce the processing steps and the difficulty of processing the paper bottom box 20.

The first convex ribs 211 can serve as reinforcing portions to improve the structural strength of the paper bottom box 20. The overall structural strength and pressure resistance of the paper bottom box 20 with the first convex ribs 211 are relatively high, making the entire paper bottom box 20 less prone to deformation and crush under external force.

The paper bottom box 20 is a one-piece molded structure. The direct formation of the first convex ribs 211 on the third body 21 replaces separate processing and then assembly of the third body 21 and the first convex ribs 211, which can cancel the process of separately processing the first convex ribs 211 and bonding the first convex ribs 211 to the third body 21 with an adhesive, and can also cancel the use of the adhesive to improve the environmental friendliness of the box assembly 10.

In some embodiments, as shown in FIGS. 5, 7, and 10, the paper upper holder 50 includes a first body 51. A portion of the first body 51 protrudes to form second convex ribs 511. The second convex ribs 511 are inserted into the first recesses 202. The second convex ribs 511 press against the vertical bobbin portions 32 of the paper floss bobbin 30.

The second convex ribs 511 can serve as reinforcing portions to improve the structural strength of the paper upper holder 50. The overall structural strength and pressure resistance of the paper upper holder 50 with the second convex ribs 511 are relatively high, making the paper upper holder 50 less prone to deformation and collapse under external force.

The paper upper holder 50 is a one-piece molded structure. The direct formation of the second convex ribs 511 on the first body 51 replaces separate processing and then assembly of the first body 51 and the second convex ribs 511, which can cancel the process of separately processing the second convex ribs 511 and bonding the second convex ribs 511 to the first body 51 with an adhesive, and can also cancel the use of the adhesive to improve the environmental friendliness of the box assembly 10.

During the assembly of the paper upper holder 50 and the paper bottom box 20, the second convex ribs 511 of the paper upper holder 50 are aligned and inserted into the first recesses 202 of the paper bottom box 20, and then pressure is applied to the paper upper holder 50 to press the paper upper holder 50 into the paper bottom box 20. The second convex ribs 511 and the first recesses 202 can form positioning structures, which facilitate accurate and rapid assembly of the paper upper holder 50 and the paper bottom box 20, also reduce the possibility that the paper upper holder 50 gets stuck in the paper bottom box 20 due to positional deviation of the paper upper holder 50 during pressing, and improve the convenience and usability of disassembling and assembling the paper upper holder 50.

In some embodiments, as shown in FIGS. 5, 7, and 10, the first body 51 of the paper upper holder 50 is provided with second recesses 503 corresponding to the second convex ribs 511. The second recesses 503 are in communication with the second accommodating cavity 501.

In the case that the paper upper holder 50 is processed, the second convex ribs 511 and the second recesses 503 can be formed in the same process, to reduce the processing steps and the difficulty of processing the paper bottom box 20.

The first body 51 is provided with the second recesses 503, which can reduce material usage for the first body 51 and lower processing costs, and facilitate de-molding of the paper upper holder 50 and reduce the difficulty of processing the paper upper holder 50 in the case that the paper upper holder 50 is formed using the pulp molding process.

In some embodiments, as shown in FIGS. 4, 5, and 10, the first flange 52 of the paper upper holder 50 includes a first notch 521. The third flange 22 of the paper bottom box 20 includes a second notch 221. The first notch 521 corresponds to the second notch 221. In the case that the paper cover body 60 is in the closed position, the first flange 52, the second flange 62, and the third flange 22 overlap, and a portion of the second flange 62 is exposed from the first notch 521.

The portion of the second flange 62 exposed in the first notch 521 can serve as a finger position to open the paper cover body 60. The user can operate the box assembly 10 with one hand. The user's fingers can be placed on the portion of the second flange 62 exposed in the first notch 521, then apply a flipping torque to the paper cover body 60 to separate the paper cover body 60 from the paper upper holder 50, and place the paper cover body 60 in the open position to improve the convenience of using the box assembly 10. For example, the user can hold the paper bottom box 20 with the palm and apply a flipping torque to the second flange 62 with the thumb to open or close the paper cover body 60.

For example, the first flange 52 of the paper upper holder 50 has an edge away from a hinge position of the paper cover body 60 and the paper upper holder 50, and the first notch 521 is provided at the edge. The third flange 22 of the paper bottom box 20 has an edge away from a hinge position of the paper cover body 60 and the paper upper holder 50, and the second notch 221 is provided at the edge. For example, the shape of the first notch 521 may be the same as that of the second notch 221.

In some embodiments, at least one of the paper bottom box 20, the paper floss bobbin 30, the paper upper holder 50, or the paper cover body 60 is formed by curing raw materials including bamboo pulp and bagasse pulp, a total mass of the bamboo pulp in the raw materials accounts for 35%, and a total mass of the bagasse pulp in the raw materials accounts for 65%.

The bamboo pulp includes bamboo fibers. The bamboo fibers are compact in structure and relatively long in fiber length. The bamboo fibers have good mechanical properties such as elastic modulus and tensile strength. The bamboo fibers can improve the tensile strength of processed paper parts, to improve the elasticity of the paper parts. The paper parts including bamboo fibers can deform and are less prone to cracking under force. The bagasse pulp includes bagasse. The bagasse has relatively short fibers and good flexibility. The total mass of the bamboo pulp in the raw materials accounts for 35%, and the total mass of the bagasse pulp in the raw materials accounts for 65%, which can ensure that the paper parts have high strength, elasticity, and flexibility.

The paper upper holder 50 is detachably connected to the paper bottom box 20 by friction fit. At least one of the paper upper holder 50 or the paper bottom box 20 is formed by curing raw materials including bamboo pulp and bagasse pulp, and at least one of the paper upper holder 50 or the paper bottom box 20 has elasticity. Therefore, in the process of pressing the paper upper holder 50 into the paper bottom box 20, at least one of the paper upper holder 50 or the paper bottom box 20 can undergo elastic deformation. After the paper upper holder 50 is pressed into the paper bottom box 20, the paper upper holder 50 and the paper bottom box 20 can press each other to maintain a stable connection state under the action of elastic recovery force, making it difficult to separate the paper upper holder 50 and the paper bottom box 20.

In the case that the paper cover body 60 is in the closed position, a portion of the paper cover body 60 is located in the second accommodating cavity 501 of the paper upper holder 50. The paper cover body 60 is connected to the paper upper holder 50 by friction fit. At least one of the paper cover body 60 or the paper upper holder 50 is formed by curing raw materials including bamboo pulp and bagasse pulp, and at least one of the paper cover body 60 or the paper upper holder 50 has elasticity. In the case that the paper cover body 60 is in the closed position, at least one of the paper cover body 60 or the paper upper holder 50 can undergo elastic deformation. The paper cover body 60 and the paper upper holder 50 can press each other to maintain a stable connection state under the action of elastic recovery force, making it difficult to accidentally flip and open the paper cover body 60.

In some embodiments, the paper bottom box 20, the paper floss bobbin 30, the paper upper holder 50, and the paper cover body 60 are all formed by curing raw materials including bamboo pulp and bagasse pulp.

Although the present application is described with reference to the embodiments, various improvements can be made and equivalents can be substituted for components therein without departing from the scope of the present application. In particular, as long as there is no structural conflict, various features mentioned in the embodiments can be combined in any way. The present application is not limited to the specific embodiments disclosed herein, but includes all solutions falling within the scope of the claims.

What is claimed is:

1. A box assembly, comprising:
a paper bottom box comprising a first accommodating cavity;
a paper floss bobbin arranged in the first accommodating cavity and configured to support a floss roll; and
a cover component comprising a paper upper holder, a paper cover body, and a floss cutter, at least a portion of the paper upper holder being located in the first accommodating cavity, the paper upper holder being detachably connected to the paper bottom box only by friction fit, the paper upper holder comprising a second accommodating cavity and an outlet opening, the outlet opening connecting the first accommodating cavity and the second accommodating cavity, the paper cover body being hinged with the paper upper holder, the paper cover body being configured to flip relative to the paper upper holder to switch between an open position and a closed position, and the floss cutter being arranged on the paper cover body,
wherein in the case that the paper cover body is in the closed position, the paper cover body covers the second accommodating cavity and the outlet opening, and the floss cutter and at least a portion of the paper cover body are located in the second accommodating cavity, and the paper cover body is connected to the paper upper holder only by friction fit; in the case that the paper cover body is in the open position, the outlet opening and the floss cutter are exposed.

2. The box assembly according to claim 1, wherein the paper upper holder and the paper cover body are of a one-piece molded structure.

3. The box assembly according to claim 1, wherein the paper upper holder comprises a first body and a first flange, the first body being located in the first accommodating cavity and detachably connected to the paper bottom box only by friction fit, the first body being provided with the second accommodating cavity and the outlet opening, and the paper cover body being hinged with the first flange.

4. The box assembly according to claim 3, wherein the paper cover body comprises a second body and a second flange that is hinged with the first flange, the floss cutter being arranged on the second body; in the case that the paper cover body is in the closed position, the first flange overlaps with the second flange, and the second body is located in the second accommodating cavity and connected to the paper upper holder only by friction fit.

5. The box assembly according to claim 4, wherein the second body has a floss fixing portion spaced apart from the floss cutter.

6. The box assembly according to claim 4, wherein the cover component comprises a paper cover plate connected to the paper cover body, the second body is provided with a third accommodating cavity having an opening which faces away from the paper upper holder, and the paper cover plate covers the third accommodating cavity.

7. The box assembly according to claim 4, wherein the paper floss bobbin comprises a transverse bobbin portion and vertical bobbin portions, the transverse bobbin portion being configured to support the floss roll, two ends of the transverse bobbin portion being connected to the paper bottom box by lap-joint, two of the vertical bobbin portions are spaced apart on the transverse bobbin portion, the vertical bobbin portions extending towards the paper upper holder, and the first body pressing against the vertical bobbin portions.

8. The box assembly according to claim 7, wherein the paper bottom box comprises two first recesses spaced apart, each of which is in communication with the first accommodating cavity and is provided with a bottom wall, a gap being provided between the bottom wall and a bottom surface of the first accommodating cavity, two ends of the transverse bobbin portion being connected to the bottom walls of the two first recesses by lap-joint respectively, and at least a portion of the vertical bobbin portion is located in the first recess.

9. The box assembly according to claim 8, wherein the paper bottom box comprises a third body and a third flange, the third body being provided with the first accommodating cavity, the two first recesses are arranged on the third body, and the first flange overlapping with the third flange.

10. The box assembly according to claim 9, wherein a portion of the third body protrudes to form first convex ribs matching with the two first recesses respectively.

11. The box assembly according to claim 10, wherein a portion of the first body protrudes to form second convex ribs inserting into the two first recesses respectively and pressing against the vertical bobbin portions.

12. The box assembly according to claim 11, wherein the first body is provided with second recesses matching with the second convex ribs and being in communication with the second accommodating cavity.

13. The box assembly according to claim 9, wherein the first flange comprises a first notch, and the third flange comprises a second notch corresponding to the first notch; in the case that the paper cover is in the closed position, the first flange, the second flange, and the third flange overlap, and a portion of the second flange is exposed from the first notch.

14. The box assembly according to claim 4, wherein the second body has an avoidance opening; the floss cutter comprises a first clamping piece, a connecting piece, a second clamping piece, and a cutting blade, the connecting piece connecting the first clamping piece and the second clamping piece and being inserted into the avoidance opening, the floss cutter being clamped to the second body by the first clamping piece and the second clamping piece, the first clamping piece being located on a side of the second body facing the paper upper holder, the second clamping piece being located on a side of the second body away from the paper upper holder, and the cutting blade being arranged on the first clamping piece.

15. The box assembly according to claim 1, wherein at least one of the paper bottom box, the paper floss bobbin, the paper upper holder, or the paper cover body is formed by curing raw materials comprising bamboo pulp and bagasse pulp, a total mass of the bamboo pulp accounting for 35% of the raw materials, and a total mass of the bagasse pulp accounting for 65% of the raw materials.
